(19) United States
(12) Patent Application Publication
(10) Pub. No.: US 2012/0191671 A1
(43) Pub. Date: Jul. 26, 2012

(54) COMPUTER SYSTEM AND DATA DE-DUPLICATION METHOD

(75) Inventors: Masayuki Kitamura, Odawara (JP); Takuya Okamoto, Machida (JP)

(73) Assignee: Hitachi, Ltd.

(21) Appl. No.: 13/058,288

(22) PCT Filed: Jan. 26, 2011
(86) PCT No.: PCT/JP2011/000421

§ 371 Date: Feb. 9, 2011

(51) Int. Cl. G06F 17/30

(52) U.S. Cl. 707/692; 707/E17.01

(57) ABSTRACT

A computer system and data de-duplication method capable of performing efficient data de-duplication are suggested.

With a computer system including a plurality of first file storage apparatuses and a second file storage for storing and retaining file data of a target file(s) to be stored, which is sent from each of the first file storage apparatuses, the first file storage apparatus obtains sameness judgment information about the target file to be stored; compares the obtained sameness judgment information with the sameness judgment information about each file, which was reported from the second file storage in advance and is stored and retained by the second file storage apparatus; and sends reference information, which refers to a file that is stored and retained in the second file storage apparatus and is the same as the target file to be stored, to the second file storage apparatus if it is determined that the same file as the target file to be stored, is stored and retained in the second file storage apparatus.

### TECHNICAL FIELD

The present invention relates to a computer system and a data de-duplication method. Particularly, the invention is suited for use in a computer system for backing up or archiving file data of files, which are stored in a plurality of first file storage apparatus, to a second file storage apparatus.

### BACKGROUND ART

It has been conventionally widespread practice among, for example, companies to save (back up or archive) file data of files, which are stored in file storage apparatuses installed at bases such as branches, offices, or divisions, in a large-capacity file storage apparatus (hereinafter referred to as the large-capacity file storage apparatus) installed at, for example, a data center.

In this case, file data containing the same content is often stored redundantly in a file storage apparatus at one base by a plurality of users. If the file data of these same files are separately saved in the large-capacity file storage apparatus, the capacity of the large-capacity file storage apparatus will be consumed more than necessary.

Therefore, a data de-duplication technology has been conventionally suggested as a technique for preventing such large-capacity file storage apparatus from retaining the file data of the same content redundantly. This data de-duplication technique is a technique for recognizing any one file from among a plurality of files of the same content saved in the large-capacity file storage apparatus as a reference source file and replacing file data of the files other than the reference source file with reference information which refers to the reference source file. According to this data de-duplication technique, the used capacity of the large-capacity file storage apparatus can be reduced.

It should be noted that Patent Literature 1 mentioned below discloses a method for, when migrating file data from a first storage site to a remote second storage site, saving information for displaying a storage location of a migrated file at a position of a migration source file in a storage system at the first storage site.

### CITATION LIST

### Patent Literature

PTL 1: [Patent Literature 1] Japanese Patent Application Laid-Open (Kokai) Publication No. 2009-289252

### SUMMARY OF INVENTION

### Technical Problem

However, according to the conventional data de-duplication technique, such data de-duplication processing can be performed only for each file storage apparatus, and the data de-duplication processing between a plurality of file storage apparatuses cannot be performed. Therefore, in a case of using many files of the same content between a plurality of bases, there is a problem in that the sufficient advantageous effect of the data de-duplication processing cannot be obtained.

Furthermore, the conventional data de-duplication technique has another problem in that since the files containing the same file data are transmitted by the plurality of file storage apparatuses as described above to be saved in the large-capacity file storage apparatus, a communication band cannot be used efficiently.

In this case, improvement of the efficiency of data amount reduction at the data center and improvement of the efficiency of traffic reduction between bases and the data center are both effective for TCO reduction.

The present invention was devised in light of the circumstances described above and aims at suggesting a computer system and de-duplication method capable of efficient data de-duplication.

### Solution to Problem

In order to solve the above-described problems, a computer system includes: a plurality of first file storage apparatuses for, in response to a request from a higher-level device, storing and retaining file data of a file given from the higher-level device or providing the higher-level device with the file data of the stored and retained file; and a second file storage apparatus for storing and retaining the file data of the file which is a target to be stored and is sent from each of the first file storage apparatuses; wherein the first file storage apparatus obtains sameness judgment information to be used to judge sameness of the target file to be stored with another file, based on the file data of that file; the first file storage apparatus compares the obtained sameness judgment information about the target file to be stored with the sameness judgment information about each file, which was reported by the second file storage apparatus in advance and stored and retained by the second file storage apparatus; and if it is determined that the same file as the target file to be stored is not stored or retained in the second file storage apparatus, the first file storage apparatus sends the file data of the target file to be stored, to the second file storage apparatus; and if it is determined that the same file as the target file to be stored is stored and retained in the second file storage apparatus, the first file storage apparatus sends reference information, which refers to the file that is stored and retained in the second file storage apparatus and is the same as the target file to be stored, to the second file storage apparatus; and wherein the second file storage apparatus manages the sameness judgment information about each file stored and retained on a file basis and notifies each first file storage apparatus of the sameness judgment information about the file required.

Furthermore, a data de-duplication method for a computer system is provided wherein the computer system includes a plurality of first file storage apparatuses for, in response to a request from a higher-level device, storing and retaining file data of a file given from the higher-level device or providing the higher-level device with the file data of the stored and retained file, and a second file storage apparatus for storing and retaining the file data of the file which is a target to be stored and is sent from each of the first file storage apparatuses. The data de-duplication method includes: a first step executed by the first file storage apparatus of obtaining sameness judgment information to be used to judge sameness of the target file to be stored with another file, based on the file data of that file; comparing the obtained sameness judgment information about the target file to be stored with the sameness judgment information about each file, which was reported by the second file storage apparatus in advance and stored and retained by the second file storage apparatus; and sending the file data of the target file to be stored, to the second file storage apparatus if it is determined that the same file as the target file to be stored is not stored or retained in the second file storage apparatus; and sending reference information, which refers to the file that is stored and retained in the second file storage apparatus and is the same as the target file to be stored, to the second file storage apparatus if it is determined that the same file as the target file to be stored is stored and retained in the second file storage apparatus; and a second step executed by the second file storage apparatus of managing the sameness judgment information about each file stored and retained on a file basis and notifying each first file storage apparatus of the sameness judgment information about the file.

### Advantageous Effects of Invention

According to this invention, efficient data de-duplication can be performed for file data that exists across file storage apparatuses at a plurality of bases.

### BRIEF DESCRIPTION OF DRAWINGS

FIG. 1 is a block diagram showing the entire configuration of a computer system according to this embodiment.

FIG. 2 is a block diagram showing a configuration example for file storage apparatuses and a large-capacity file storage apparatus.

FIG. 3A is a conceptual diagram explaining data de-duplication processing.

FIG. 3B is a conceptual diagram showing a configuration example for a stub.

FIG. 4 is a conceptual diagram showing a configuration example for management information retained by which the center-side large-capacity file storage apparatus.

FIG. 5A is a conceptual diagram showing an example of data duplication status among the respective bases.

FIG. 5B is a conceptual diagram showing a configuration example for inter-base duplication rate evaluation information.

FIG. 6A is a conceptual diagram showing the configuration of a management information table transmitted to the base after determining the management information to be synchronized.

FIG. 6B is a conceptual diagram showing the configuration of the management information table transmitted to the base after determining the management information to be synchronized.

FIG. 6C is a conceptual diagram showing the configuration of the management information table transmitted to the base after determining the management information to be synchronized.

FIG. 7 is a conceptual diagram showing the entire processing of the computer system according to Embodiment 1.

FIG. 8A is a flowchart showing a processing sequence for the de-duplication processing.

FIG. 8B is a flowchart showing a processing sequence for management information synchronization processing.

FIG. 9 is a flowchart showing a processing sequence for reference processing.

FIG. 10 is a flowchart showing a processing sequence for file data deletion processing.

FIG. 11 is a flowchart showing a processing sequence for synchronization target base determination processing.

FIG. 12 is a flowchart showing a processing sequence for the management information synchronization processing.

FIG. 13 is a flowchart showing a processing sequence for base addition processing.

FIG. 14 is a flowchart showing a processing sequence for base deletion processing.

### DESCRIPTION OF EMBODIMENTS

An embodiment of this invention will be described below with reference to the figures.

### (1) Computer System according to This Embodiment

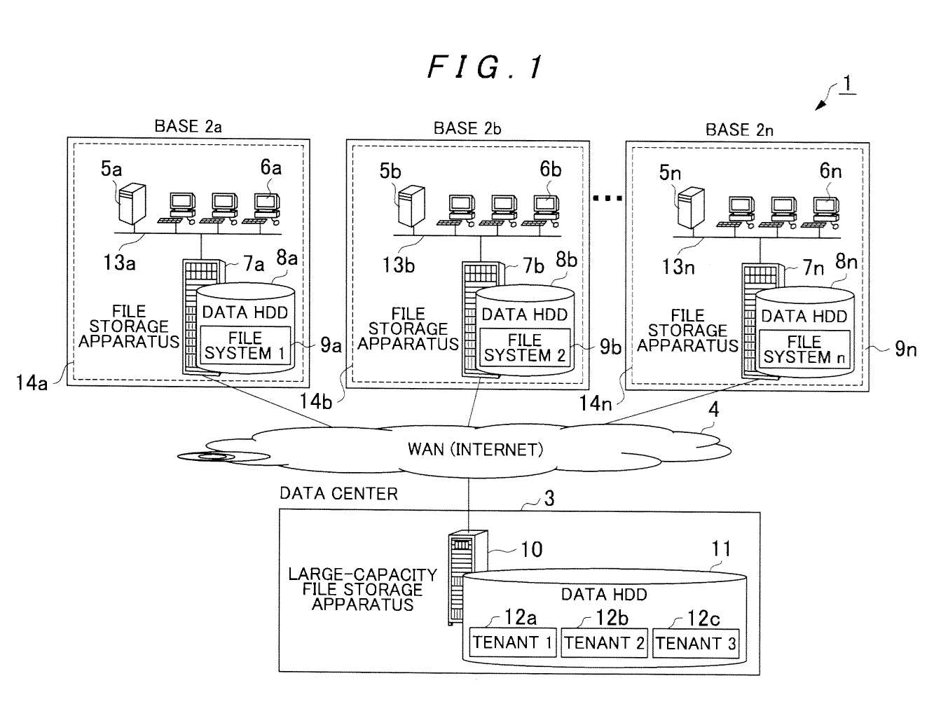

(1-1) Configuration of Computer System according to This Embodiment Referring to FIG. 1, the reference numeral 1 represents an entire computer system 1 according to this embodiment. This computer system 1 includes base-side computer system units 14 (14a, 14b, and so on up to 14n) respectively installed in a plurality of bases 2 (2a, 2h, and so on up to 2n) such as branches or offices and a large-capacity file storage apparatus 10 installed at a data center 3. It should be noted that FIG. 1 shows a case where three bases exist. Furthermore, in a case of general description of the plurality of bases, the reference signs a, b, and so on up to n might be omitted.

The plurality of bases 2 (2a, 2b, and so on up to 2n) and the data center 3 are connected via a network 4 composed of a WAN (Wide Area Network), the Internet, or others so that they can communicate with each other.

Each base-side computer system unit 14 (14a, 14b, and so on up to 14n) includes a business server 5 (5a, 5b, and so on up to 5n), clients 6 (6a, 6b, and so on up to 6n), and a file storage apparatus 7 (7a, 7b, and so on up to 7n). Then, the business server 5, the clients 6, and the file storage apparatus 7 are connected via a LAN (Local Area Network) 13 (13a, 13b, and so on up to 13n) at each base 2.

The business server 5 is a computer which provides services in response to requests from the clients 6, and includes, for example, a CPU (Central Processing Unit), a memory, and storage devices (not shown in the figure).

The file storage apparatus 7 is a storage apparatus which stores and retains data on a file basis, and includes a plurality of physical disks and controllers which control reading file data from, or writing file data to, these physical disks. The physical disks are composed of, for example, expensive disks such as SCSI (Small Computer System Interface) disks. In the file storage apparatus 7, a file system 9 (9a, 9b, and so on up to 9n) which is a storage area for storing file data of files used in each base 2 is installed in the HDDs (Hard Disc Drives) 8 (8a, 8b, and so on up to 8n) which are disks for storing data. Then, file data is read from, or written to, the file systems 9 in response to requests from the business server 5 and the clients 6 which are higher-level devices in the same base 2.

The large-capacity file storage apparatus 10 includes a large-capacity data HDD 11 which is a data storage disk for storing and retaining file data transmitted from each of the file storage apparatuses 7 at the respective bases 2. Then, tenants 12 (12a, 12b, 12c, and so on up to 12n) corresponding to the file systems 9 for the file storage apparatuses 7 at the respective bases 2 are installed in this data HDD 11. The tenants 12 indicate logically partitioned storage areas. In this embodiment, the tenant 12 indicates a storage area, which is allocated to each base 2, in the large-capacity file storage apparatus 10 in the data center 3.

Each base-side computer system unit 14 can store back-up target data or archive target data on a file basis from the file storage apparatus 7 at each base 2 to the corresponding tenant 12 in the large-capacity file storage apparatus 10 at the data center 3 via the network 4. The file data stored in such tenant 12 by each base-side computer system unit 14 is stored and retained by the large-capacity file storage apparatus 10.

The computer system 1 according to this embodiment is designed so that the file storage apparatuses 7 installed at the respective bases 2 and the large-capacity file storage apparatus 10 installed at the data center 3 collaborate to perform de-duplication of file data efficiently.

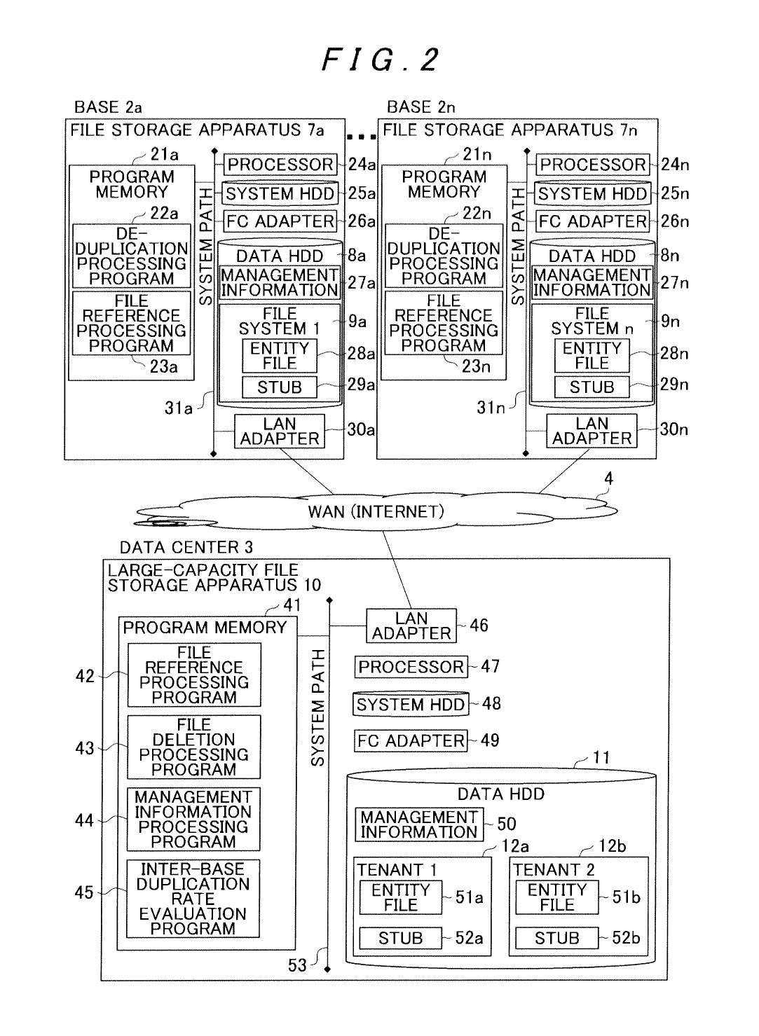

FIG. 2 shows a configuration example for the file storage apparatuses 7 at the bases 2 and the large-capacity file storage apparatus 10 at the data center 3 in the computer system 1 shown in FIG. 1.

The file storage apparatus 7 installed at the base 2 includes a program memory 21 (21a, through 21n), a processor 24 (24a, through 24n), a system HDD 25 (25a, through 25n), an FC (Fibre Channel) adapter 26 (26a, through 26n), and a LAN adapter 30 (30a, through 30n). Then, the program memory 21, processor 24, system HDD 25, FC adapter 26, and LAN adapter 30 are connected via a system path 31 (31a, through 31n).

The program memory 21 (21a through 21n) stores a de-duplication processing program 22 (22a through 22n) and a file reference processing program 23 (23a through 23n). The program memory 21 is mainly used to store various types of software read from the system HDD 25 (25a through 25n) and various types of information read from data HDD 8 (8a through 8n), and also used as a work memory for the processor 24 (24a through 24n).

The processor 24 has a function controlling the operation of the entire file storage apparatus 7. The system HDD 25 is used to store various types of software. The de-duplication processing program 22 and the file reference processing program 23 are also stored and retained in the system HDD 25. These programs are read from the system HDD 25 to the program memory 21 when activating the file storage apparatus 7, and are executed by the processor 24. It should be noted that the basic software (OS) (not shown in the drawing) for activating the file storage apparatus 7 is also stored and retained in the system HDD 25, read to the program memory 21, and executed by the processor 24.

The FC adapter 26 (26a through 26n) is connected to the data HDD 8 (8a through 8n) via the system path. The data HDD 8 is composed of management information 27 (27a through 27n) and a file system 9 (9a through 9n). Then, data from the business server 5 and the clients 6 at the base 2 is stored in the file system 9 for the HDD 8 connected to the FC adapter 26.

The file system 9 (9a through 9n) stores, in addition to files including file entities (hereinafter referred to as entity files) 28 (28a through 28n), stubs 29 (29a through 29n) including reference (link) information about the entity files 28 created when the entity files 28 are hacked up and archived to the large-capacity file storage apparatus 10 on the data center 3 side are stored. It should be noted that a plurality of file systems 9 may sometimes exist at one base 2. Furthermore, the data HDD 8 in the file storage apparatus 7 on the base 2 side also stores management information 27 (27a through 27n) which stores the file information about the entity files 28 and the stubs 29 shared by the large-capacity file storage apparatus 10 on the data center 3 side.

The LAN adapter 30 (30a through 30n) is an adapter for connecting the file storage apparatus 7 to the network 4.

Meanwhile, the center-side large-capacity file storage apparatus 10 includes a program memory 41, a LAN adapter 46, a processor 47, a system HDD 48, and an FC adapter 49, which are mutually connected via a system path 53.

The program memory 41 stores a file reference processing program 42, a file deletion processing program 43, a management information processing program 44, and a duplication rate evaluation program 45 among the bases 2. The program memory 41 is mainly used to store various types of software read from the system HDD 48 and various types of information read from the data HDD 11, and is also used as a work memory for the processor 47.

The processor 47 has a function controlling the operation of the entire large-capacity file storage apparatus 10. The system HDD 48 is used to store various types of software. The file reference processing program 42, the file deletion processing program 43, the management information processing program 44, and the inter-base duplication rate evaluation program 45 are also stored and retained in this system HDD 48. These programs are read from the system HDD 48 to the program memory 41 when activating the large-capacity file storage apparatus 10, and are executed by the processors 47.

The entity files 28 or the stubs 29 from the file storage apparatuses 7 on the base 2 side are stored in the tenants 12 (12a, 12b, and so on) in the data HDD 11 connected to the FC adapter 49 in the data center 3. In the large-capacity file storage apparatus 10 on the data center 3 side, the tenants 12 (12a, 12b, and so on), the number of which corresponds to the number of the file systems 9 (9a, 9b, and so on) in the file storage apparatuses 7 at the bases 2, exist.

The data HDD 11 of the large-capacity file storage apparatus 10 on the data center 3 side also stores management information 50 related to the entity files 51 (51a, 51b, and so on) and the stubs 52 (52a, 52b, and so on) registered in the respective tenants 12.

The file storage apparatuses 7 of the respective bases 2 and the large-capacity file storage apparatus 10 on the data center 3 side are respectively connected to the network 4 via the LAN adapters 46, and can mutually transmit and receive file data.

This embodiment describes a case where the entity files 51 are stored in the tenants 12 in the large-capacity file storage apparatus 10 on the data center 3 side; however, the embodiment also includes a case where the files are stored in the file systems 9 in the file storage apparatuses 7 of the bases 2 instead of the tenants 12.

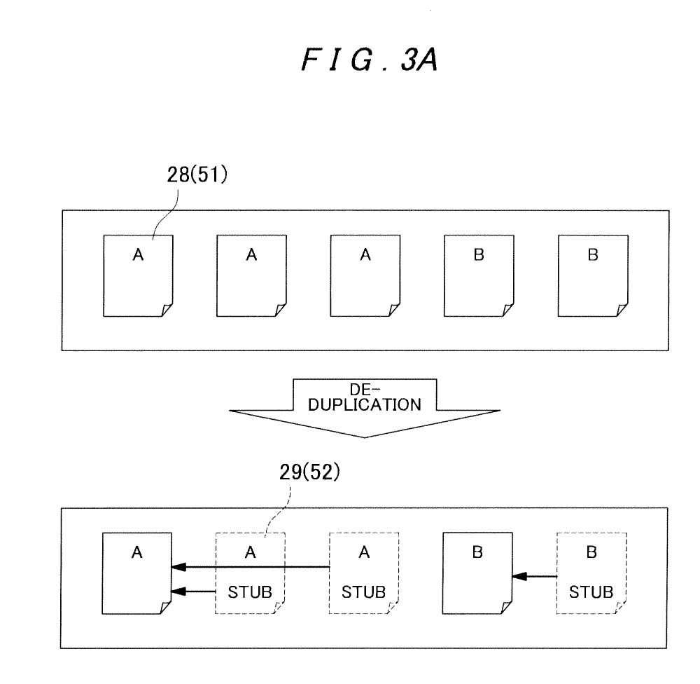

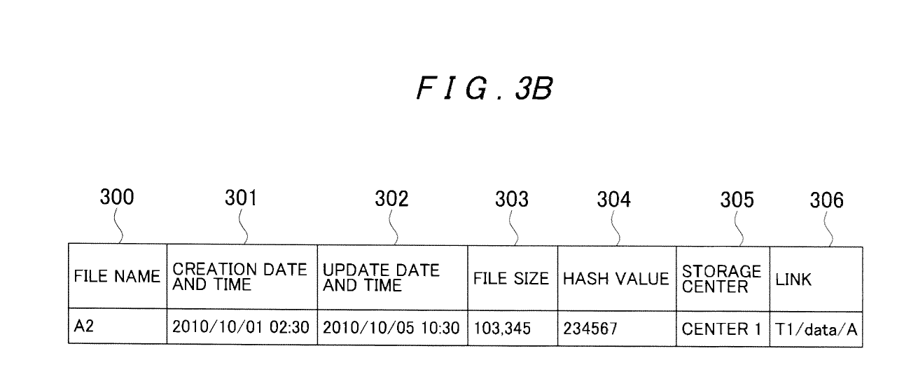

FIG. 3A shows the concept of the data de-duplication processing executed in the file storage apparatuses 7 and the large-capacity file storage apparatus 10. This data de-duplication processing is the processing for, if a plurality of files of the same content exist, keeping the file data in one of those files as an original and replacing the file data of the other files with stubs (files including reference (link) information to the original file). The data amount of the stubs, which do not include the entity (content) of the file data and include the information such as links and file names, is smaller than that of the entity files, so that this data de-duplication processing can reduce the data amount as a whole.

FIG. 3A shows a processing example of the data de-duplication processing in a case where three entity files A 28, 51 of the same content and two entity files B 28, 51 of the same content exist in the file storage apparatus 7 or in the large-capacity file storage apparatus 10. If duplicate entity files exist, an entity file 28, 51 which is considered to be an original is kept while the other entity files 28, 51 are replaced with stubs 29, 52. As a result, the file data amount of the file A which is the entity file can be reduced to ⅓, and the file data amount of the file B which is the entity file can be reduced to ½. Furthermore, since the file data amount of the stubs 29, 52 corresponding to the entity file A and the entity file B is smaller than that of the entity file A and the entity file B, the entire file data amount can also be reduced.

It should be noted that whether the file data of the entity files 28, 51 is the same or not is checked by combining comparison of, for example, hash values and data sizes of the entity files 28, 51. As the comparison is performed for the entity files 28, 51, even if the three entity files A and the two entity files B have respectively different file names, if the entity files are of the same content, the file data amount can be reduced by de-duplication.

It should be noted that the hash value is a hash value generated based on the content of the entity file 28, 51. The result of calculation of the file data of a certain file by using a specified hash function is the hash value. If the original data is different, the hash values which are the results of calculation of such data are also normally different and the same hash values are rarely obtained. This embodiment uses one type of hash value, but in the actual application a plurality of types of hash values may be used to increase the accuracy of the file data consistency check.

FIG. 3B shows an example of the information configuration of a stub 29, 52 which is used in the data de-duplication processing. This stub 29, 52 has a table structure constituted from a file name field 300, a creation date and time field 301, an update date and time field 302, a file size field 303, a hash value field 304, a storage center field 305, and a link field 306.

The file name field 300 stores the file name of an original file stored in the file storage apparatus 7 before being changed to a stub. The creation date and time field 301 stores information about the date and time when the stub 29, 52 was created. The update date and time field 302 stores the latest date and time when the file data of the stub 29, 52 was updated. The file size field 303 stores a file size value of the entity file 51 to which the stub 29, 52 refers, the hash value field 304 stores a hash value of the entity file 51 to which the stub 29, 52 refers. Furthermore, the storage center field 305 stores path information indicating a path to the data center 3 in which the stub 29, 52 is stored. It should be noted that this embodiment has described an example of the computer system constituted from one data center 3; however, the invention is not limited to this example, and the computer system may also be constituted from a plurality of data centers 3. The link field 306 stores link information indicating a link to the file data of the original entity file 28, 51 for the stub 29, 52.

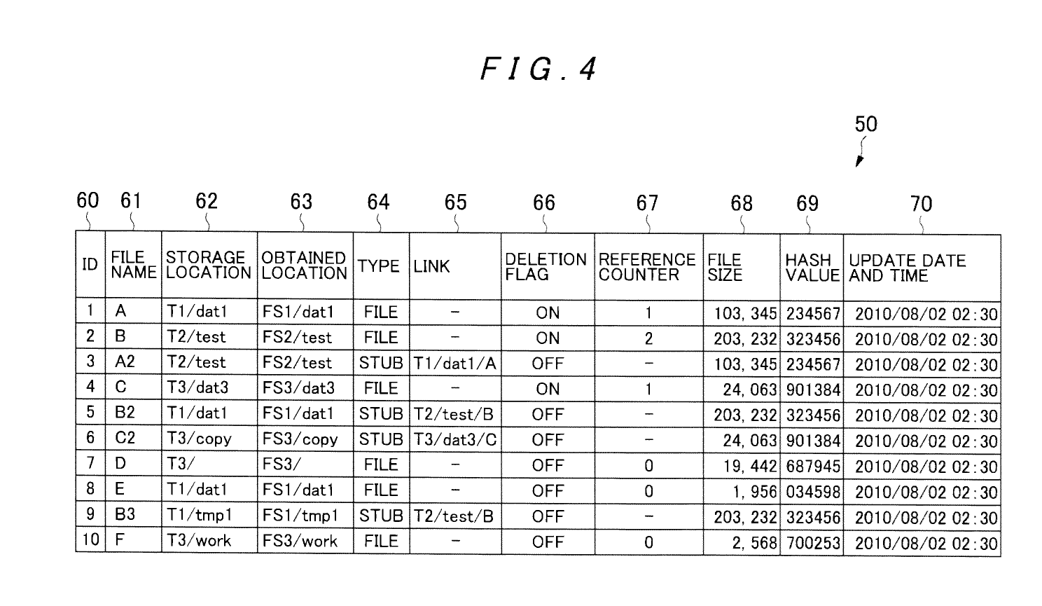

FIG. 4 shows a configuration example for management information 50 retained by the large-capacity file storage apparatus 10 of the data center 3. The management information 50 is information used to manage the entity files 51 and the stubs 52 stored in the respective tenants 12 in the large-capacity file storage apparatus 10 of the data center 3.

This management information 50, as shown in FIG. 4, has a table structure constituted from an ID field 60, a file name field 61, a storage location field 62, a obtained location field 63, a type field 64, a link field 65, a deletion flag field 66, a reference counter field 67, a file size field 68, a hash value field 69, and an update date and time field 70.

The file name field 61 stores the file name of the relevant file (an entity file 51 or an original file of the stub 52 before being changed to a stub). Furthermore, the storage location field 62 stores path information indicating a path to the storage location of the file data of the file in the large-capacity file storage apparatus 10. This path information includes the tenant 12 and the directory.

Furthermore, the obtained location field 63 stores the identification of the file system 9 managing the file data in the file storage apparatus 7 which transmitted the file data of the relevant file, and the identification of the directory in which the relevant file data is stored in the relevant file system 9.

The type field 64 indicates whether the relevant file data is an entity file 51 or a stub 52. If the relevant file data is an entity file 51, a code indicating FILE is stored in the type field 64; and if the relevant file data is a stub 52, a code indicating STUB is stored in the type field 64.

If the relevant data is a stub 52, the link field 65 stores link information indicating a link to the file data of the original entity file 51. This link information includes identification information of the tenant 12, in which such original entity file 51, is stored and identification information of the directory in which the relevant entity file 51 is stored in the relevant tenant 12. It should be noted that this link field 65 is not used if the relevant file data is an entity file 51.

The deletion flag field 66 stores a flag indicating whether there is a deletion request for the entity file 51 and the stub 52 from the business server 5 and the client 6 or not (hereinafter referred to as the deletion flag). This deletion flag is set to ON if there is a deletion request for the file data from the business server 5 and the client 6; and the deletion flag is set to OFF if there is no deletion request. It should be noted that even if the deletion flag is changed to ON, unless the reference counter number shown in the reference counter field 67 described below is 0, the file data is not deleted. The details will be explained later.

The reference counter field 67 stores the number of references to the original entity file 51 from the stub 52. If a stub referring to the entity file is registered, the reference counter number stored in the reference counter field 67 is incremented (increased by one); and if the stub is deleted, the reference counter number is decremented (decreased by one). It should be noted that since no reference file for the stub 52 exists, the reference counter number corresponding to the stub 52 is not stored in the reference counter field 67.

If the business server 5 and the client 6 make a deletion request for the entity file 51 and the stub 52, the deletion flag corresponding to the file data is changed to ON in the deletion flag field 66. Since no reference file corresponding to the stub 52 exists, the stub is deleted in the reference counter field 67 when the business server 5 and the client 6 make a deletion request for the stub 52. Meanwhile, regarding the entity file 51, if the reference counter number indicated in the reference counter field 67 is 0, the file data of the entity file 51 is deleted.

Specifically speaking, if the reference counter is 1 or larger, even if there is a deletion request for the original entity file 51, reference is made to the entity file 51] by another stub 52, so that the deletion flag is set to ON, and the entity file 51 is not deleted. In a case of the entity file 51 or the stub 52 whose reference counter is 0, reference is not made to the entity file 51 or the stub 52 by another stub 52, so that the entity file 51 or the stub 52 is deleted at the same time as the deletion flag is changed to ON. If the reference number is changed to 0 when the deletion flag of the entity file 51 is ON, the entity file 51 is deleted.

The file size field 68 stores the file size of the relevant data. If the type of the relevant data is an entity file 51, the file size field 68 stores a file size value of the entity file 51; and if the type is a stub 52, the file size field 68 stores a file size value of the entity file 51 to which reference is made.

The hash value field 69 stores a hash value of the relevant data. If the type of the relevant data is an entity file 51, the hash value field 69 stores a hash value of the entity file 51; and if the type is a stub 52, the hash value field 69 stores a hash value of the entity file 51 to which reference is made. This embodiment uses one type of hash value, but a plurality of types of hash values may be used in the actual application to increase the accuracy of the file data consistency check.

The update date and time field 70 stores the date and time when the management information 50 of the entity file 51 and the stub 52 was updated last time. When transmitting the management information 50 of the large-capacity file storage apparatus 10 on the data center 3 side to the file storage apparatuses 7 on the base 2 side, if the update date and time stored in the update date and time field 70 is the same as or before the date and time of the previous synchronization with the management information 27 on the base 2 side, it is determined that the management information 50 of the file has not been changed, and the management information 50 of the file is not transmitted to the file storage apparatuses 7 on the base 2 side.

Next, the file data duplication rate evaluation information between each pair of bases 2 belonging to the large-capacity file storage apparatus 10 of the data center 3 has will be described. If de-duplication is performed in a case where there is a large amount of similar file data between the bases 2 and if the management information 50 of the file data is shared by the plurality of bases 2 and the data center 3, whether to transmit the management information 50 or not is determined in the large-capacity file storage apparatus 10 of the data center 3 according to this embodiment by utilizing the file data duplication rate evaluation information between each pair of the bases 2 in order to utilize the communication band efficiently. Examples of the duplication status of the file data between each pair of the bases 2 will be mentioned below to explain the file data duplication rate evaluation information.

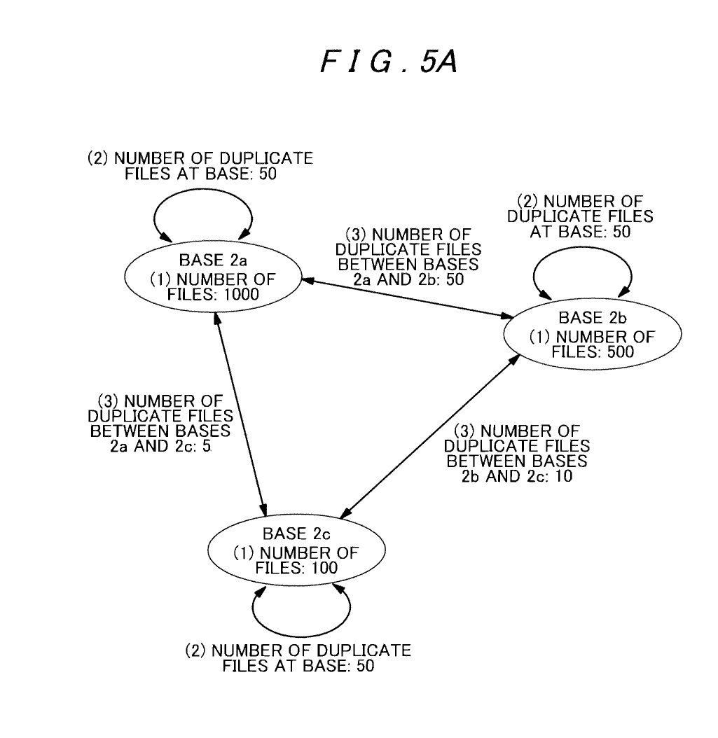

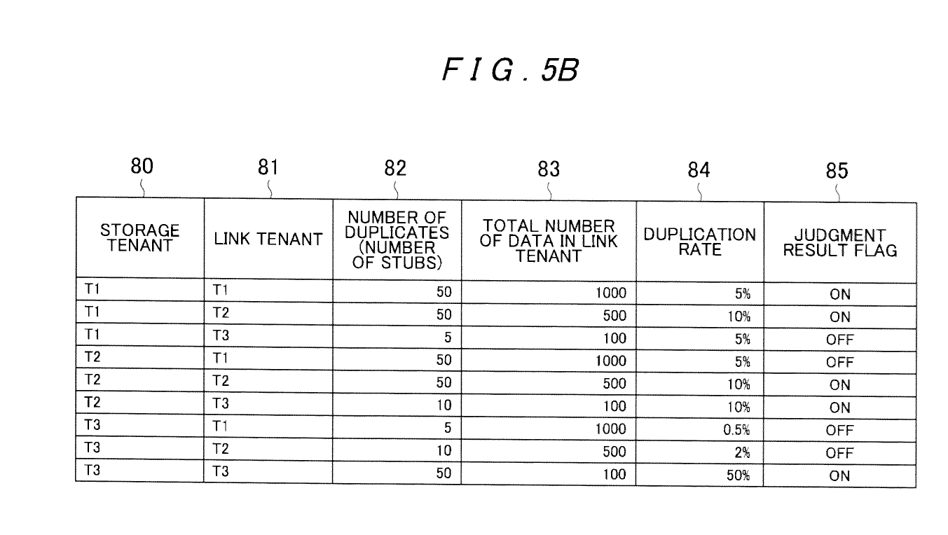

FIG. 5A shows the duplication status of the file data between each pair of the bases 2. Each circle indicates a base 2; the total number of files (entity files 28 and stubs 29) stored in each base 2 is shown inside each circle; and the arrows indicate the file data duplication relationship. In FIG. 5A, the number of bases 2 is three, and the duplicate file data status at each of the three bases 2 and between each pair of the bases 2 is shown.

FIG. 5B shows a table of duplication rate evaluation information between each pair of the bases 2. The evaluation information is the table of the evaluation information showing the effects of de-duplication of the entity files 51 between each pair of the tenants 12 (between each pair of the bases 2) in the large-capacity file storage apparatus 10 on the data center 3 side. It should be noted that the evaluation information table may be stored in the large-capacity file storage apparatus 10 each time the duplication rate is evaluated.

The evaluation information table includes, as shown in FIG. 5B, composed a storage tenant field 80, a link tenant field 81, a number-of-duplicates field 82, a total-number-of-data-in-link-tenant field 83, a duplication rate field 84, and a judgment result flag field 85.

The storage tenant field 80 stores the tenant 12 in which the file data as the target of the duplication rate evaluation is stored (that is, the tenant 12 corresponding to the base 2 which receives the management information 50 if it is determined to synchronize the management information 50). The link tenant field 81 stores the tenant 12 as a link for the file data stored in the storage tenant shown in the storage tenant field 80.

The number-of-duplicates field 82 stores the number of stubs 52 mutually linked between the storage tenant 12 and the link tenant 12. The total-number-of-data-in-link-tenant field 83 indicates the total number of files of the entity files 51 and the stubs 52 in the link tenant 12.

The duplication rate field 84 stores a ratio of the number of files of the duplicate file data to the total number of files (hereinafter referred to as the duplication rate). This duplication rate is a parameter indicating a percentage of the number of files of the duplicate file data; and a higher duplication rate indicates a higher probability that the file data of the link tenant 12 are duplicates of those in the storage tenant 12.

The judgment result flag field 85 stores the judgment result of whether to transmit the management information 50 of the files in the link tenant 12 to the file storage apparatuses 7 on the base 2 side corresponding to the storage tenant 12. In a case of a combination of tenants 12 (bases 2) whose duplication rates and de-duplication effects are high (exceeding a set threshold), ON is stored in the judgment result flag field 85. This embodiment shows an example where the threshold is set to 10%; and for the pair of the tenants 12 whose duplication rate stored in the duplication rate field 84 is 10% or larger, ON is stored in the judgment result flag field 85. Furthermore, in the judgment result flag field for duplication in the same tenant, ON is stored regardless of duplication rate. However, the threshold may also be an arbitrarily set value instead of 10%. Furthermore, a value calculated by the large-capacity file storage apparatus 10 based on, for example, the evaluation information may also be set a threshold in order to minimize the communication data amount between the bases 2 and the data center 3. Furthermore, different thresholds may also be set for respective tenants 12. Furthermore, whether ON or OFF should be set to the judgment result flag may also be determined regardless of the threshold in order to minimize the communication data amount between the bases 2 and the data center 3.

It should be noted that the duplication rate evaluation information shown in FIG. 5B shows an example of the evaluation result of a case where the data duplication between each pair of the tenants is in the state shown in FIG. 5A.

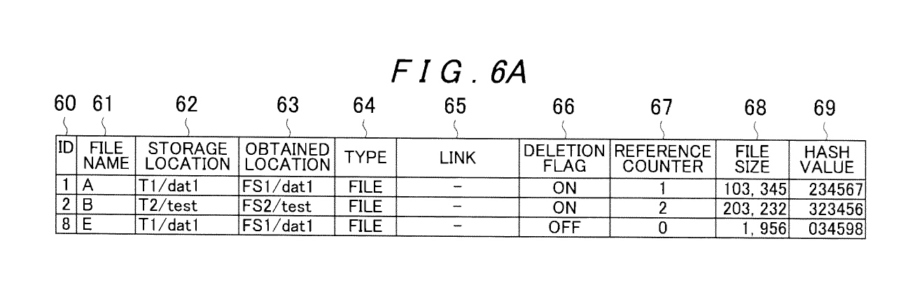

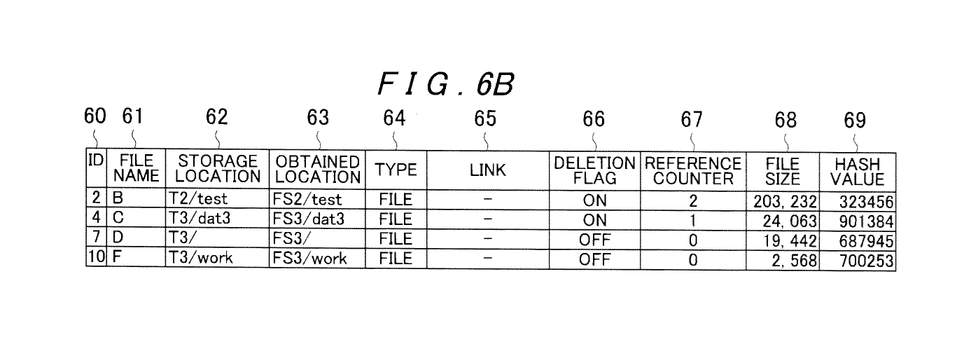

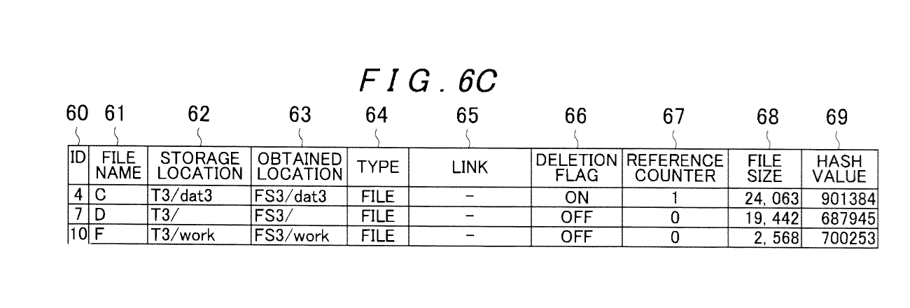

FIG. 6 shows tables of the management information 50 of the entity files 51 in the storage tenants 12 and link tenants 12 to be synchronized with the management information 27 of the file storage apparatus 7 in the base 2 corresponding to the storage tenant 12 whose flag stored in the judgment result flag field 85 of the inter-base duplication rate evaluation information in FIG. 5B is set to ON.

FIG. 6A shows the management information 50 transmitted from the data center 3 to the file storage apparatus 7a at the base 2a. FIG. 6A shows the management information 50 about the entity files 51 in the link tenant 12b for the tenant 12a, whose flag stored in the judgment result flag field 85 of the inter-base duplication rate evaluation information in FIG. 5 B is set to ON, and the management information 50 about the entity files 51 of the tenant 12a itself.

FIG. 6B shows the management information 50 transmitted from the data center 3 to the file storage apparatus 7b at the base 2b. FIG. 6B shows the management information 50 about the entity files 51 in the link tenant 12c for the tenant 12h, whose flag stored in the judgment result flag field 85 of the inter-base duplication rate evaluation information in FIG. 5B is set to ON, and the management information 50 about the entity files 51 of the tenant 12h itself.

FIG. 6C shows the management information 50 transmitted from the data center 3 to the file storage apparatus 7c at the base 2c. FIG. 6C shows the management information 50 about the entity files 51 of the tenant 12c itself because, among the flags stored in the judgment result flag field 85 of the duplication rate evaluation information between the bases 2 in FIG. 5B, there is no flag set to ON except the flag whose link is its own base 2c, that is, there is no other tenant 12 (=base 2) whose de-duplication effect is high.

It should be noted that the management information 50 to be synchronized and shared between the file storage apparatuses 7 at the respective bases 2 and the large-capacity file storage apparatus 10 at the data center 3 is to be used for the purpose of judging whether de-duplication can be performed at the bases 2 or not, so only the information about the entity files 51 may be enough. Specifically speaking, the management information 50 about the stubs 52 between the tenants 12 in the large-capacity file storage apparatus 10 does not have to be shared with the file storage apparatuses 7 at the bases 2.

As described above, the data amount in each case of the management information 50 (FIG. 6A) to be synchronized with the base 2a, the management information 50 (FIG. 6B) to be synchronized with the base 2b, and the management information 50 (FIG. 6C) to be synchronized with the base 2c is smaller than the total number of pieces of entity file information (6 files) retained by the large-capacity file storage apparatus 10 on the data center 3 side. As compared with the case where all pieces of the management information 50 in the large-capacity file storage apparatus 10 on the data center 3 side is synchronized with the file storage apparatuses 7 on the base 2 side, the communication data amount which is necessary for updating the management information 27 at each base 2 is reduced.

It should be noted that since the management information 50 about any entity file 51 to be transmitted is of the same size, the communication amount is proportional to the number of entity files 51.

### (2) Data De-duplication Processing in This Computer System

(2-1) Overview of Data De-duplication Processing in This Computer System

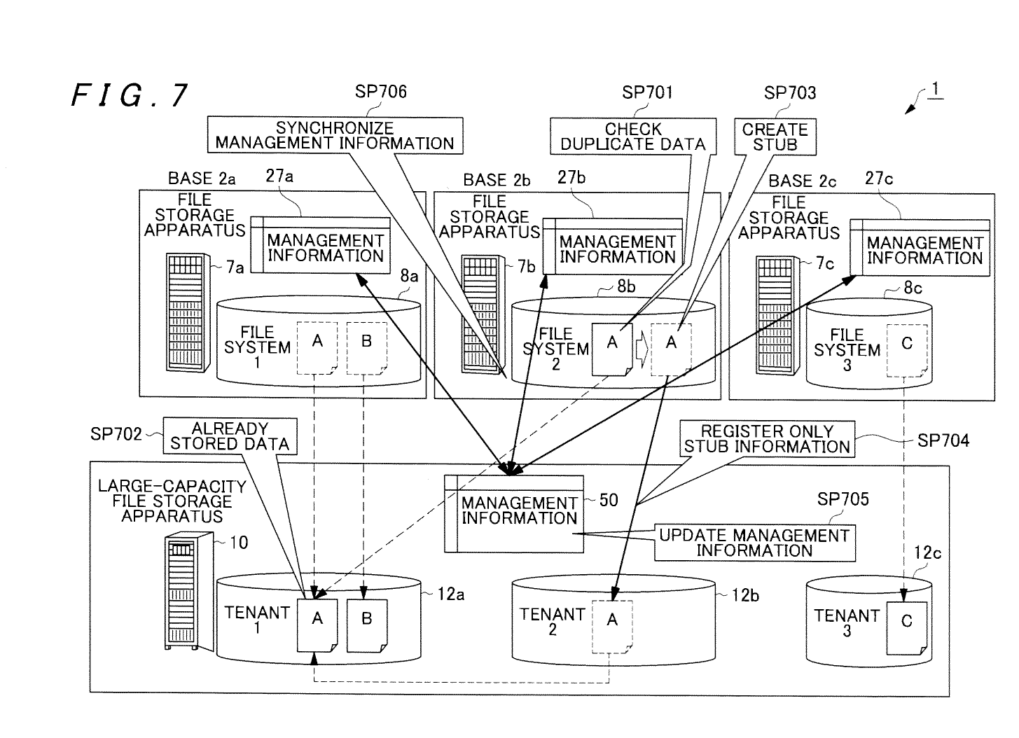

Next, the overview of the de-duplication processing according to this embodiment will be described with reference to FIG. 7. In this embodiment, de-duplication is performed between the file data stored in the file storage apparatuses 7 on the base 2 side and the file data registered in the large-capacity file storage apparatus 10 on the data center 3 side. Specifically speaking, whether the file data of the base 2 side are duplicates of those on the data center 3 side (SP701) is checked by comparing, for example, the hash values and the data size of the target file data with the management information 27 existing in the file storage apparatuses 7 on the base 2 side.

If the file data of the same content is already stored in the large-capacity file storage apparatus 10 on the data center 3 side, a stub 52 containing link information to the already existing file data is created (SP703), the stub 52 is transmitted and registered from the file storage apparatus 7 on the base 2 side to the large-capacity file storage apparatus 10 on the data center 3 side (SP704). As described above, the communication band between the file storage apparatuses 7 at the bases 2 and the large-capacity file storage apparatus 10 on the data center 3 side can be utilized efficiently by not transmitting the entity file data of the same content. Meanwhile, if no data of the same content is saved in the large-capacity file storage apparatus 10 on the data center 3 side, the file storage apparatus 7 at the base 2 transmits an entity file 28 to the large-capacity file storage apparatus 10 on the data center 3 side and register the same as new file data registration (SP702).

The information about the file data themselves and the stubs to be stored in the large-capacity file storage apparatus 10 on the data center 3 side (such as file names, hash values, and file sizes) is collectively managed as the management information 50 by the data center 3. Along with the registration of the file data to the large-capacity file storage apparatus 10 on the data center 3 side, the management information 50 in the large-capacity file storage apparatus 10 on the data center 3 side is updated (SP705).

Then, after updating the management information 50, the management information 50 updated by the large-capacity file storage apparatus 10 on the data center 3 side is transmitted to each file storage apparatus 7 on the base 2 side, and the management information 27 is shared and synchronized with the management information 50 (SP706).

When executing data deletion, if the deletion target on the data center 3 side is a stub 52, the data is deleted and the reference counter of the entity file 51, to which reference is made in the management information 50 of the large-capacity file storage apparatus 10 on the data center 3 side, is decremented by one. If the deletion target on the data center 3 side is an entity file 51, the data is deleted if the reference counter is 0. If any reference remains, the deletion flag (the flag indicating that a command is given to delete an entity file) is set to ON, and the entity file 51 is not deleted until the reference counter becomes 0. This method prevents the deletion of the entity file 51 to which any reference from the stub 52 remains.

When the data management information 27, 50 is shared by the plurality of bases 2 and the data center 3, the de-duplication relationship between the bases 2 is evaluated. The number of stubs is counted for each combination of the storage tenant 12 and the link tenant 12 with regard to the stubs 52 based on the management information 50, which the large-capacity file storage apparatus 10 on the data center 3 side has; the duplication rate to the total number of data of the files (entity files 51 and stubs 52) in the storage tenant 12 is calculated; and the inter-base duplication rate evaluation information is created.

When transmitting the management information 50 to each base 2, the information of the bases whose duplication rates and de-duplication effects are high (exceeding the de-duplication threshold) is selected and transmitted based on the duplication rate evaluation information. As a result, the communication amount is reduced compared with the case where all pieces of the management information 50 retained by the data center 3 are transmitted to each base 2.

(2-2) Overview of Data De-duplication Processing

Next, the details of the data de-duplication processing executed by the file storage apparatuses 7 on the base 2 side in such computer system 1 will be described. It should be noted that a processing subject which executes each type of processing may be sometimes described below as a program, but it is a matter of course that practically, the relevant CPU executes the processing in accordance with the program.

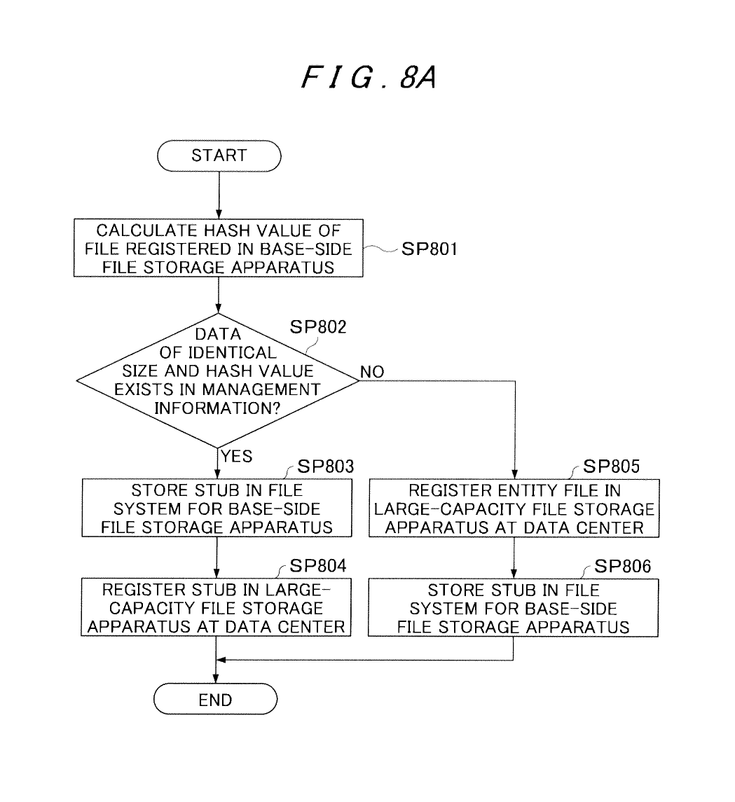

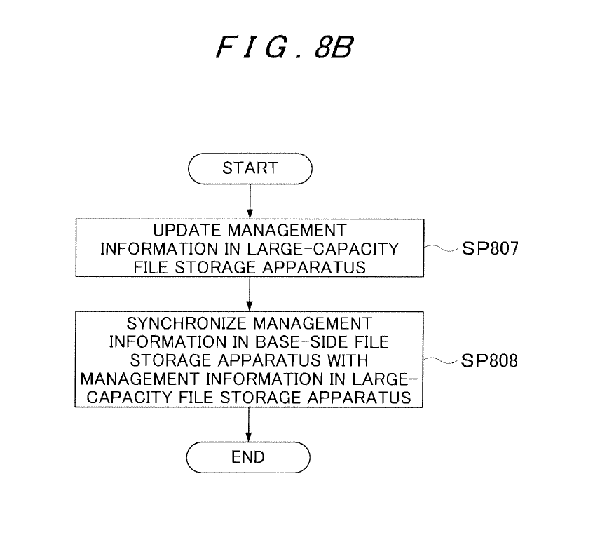

FIG. 8A shows a processing sequence for such data de-duplication processing. This data de-duplication processing is executed by the de-duplication processing program 22 in the program memory 21 in the file storage apparatus 7 which received a command from the business server 5 and the client 6 to back up or archive file data to the large-capacity file storage apparatus 10 at the data center 3 (hereinafter referred to as the save command).

Specifically speaking, after a file data save command is issued from the business server 5 and the client 6, the de-duplication processing program 22 starts the data de-duplication processing shown in FIG. 8A, that is, firstly calculates a hash value of the file data specified by the save command (SP801). It should be noted that it is mentioned above that the save command is issued from the business server 5 and the client 6, but the file storage apparatus 7 may automatically issue a save command depending on, for example, the access frequency of the file data and the elapsed time since saving of the file data.

Subsequently, the de-duplication processing program 22 refers to the management information 27 retained by the file storage apparatuses 7 on the base 2 side. Then, the program judges whether the file data of which both the file size and the hash value are consistent with those of the saving target file data exists in the large-capacity file storage apparatus 10 or not (SP802).

If an affirmative judgment is returned, the de-duplication processing program 22 creates a stub 29 including the reference information to the entity file 28 with the same file size and hash value as detected in step SP802, and replaces the saving target file data with the created stub 29 (SP803).

Subsequently, the de-duplication processing program 22 transmits the stub 29, which replaced the saving target file data in step SP803, to the large-capacity file storage apparatus 10 on the data center 3 side (SP804), and then terminates this data de-duplication processing.

Meanwhile, if a negative judgment is returned in step SP802, the de-duplication processing program 22 determines that de-duplication cannot be performed; and transmits the saving target file data of the entity file 28 to the large-capacity file storage apparatus 10 (SP805).

Then, the de-duplication processing program 22 creates a stub 29 including the reference information, which refers to such saving target entity file 51 in the large-capacity file storage apparatus 10, and replaces such saving target entity file 28 in the file system 9 with the created stub 29 (SP806). Subsequently, the de-duplication processing program 22 terminates this data de-duplication processing.

Meanwhile, FIG. 8B shows a processing sequence for management information synchronization processing regularly executed by the management information processing program 44 of the large-capacity file storage apparatus 10 which received the stub 29 transmitted from the file storage apparatus 7 in step SP804 of the above-described data de-duplication processing or the saving target file data of the entity file 28 transmitted from the file storage apparatus 7 in step SP805 of the relevant data de-duplication processing.

After receiving such saving target file data (entity file 28 or stub 29) from the file storage apparatus 7, the management information processing program 44 stores the relevant file data in the large-capacity file storage apparatus 10 and starts this management information synchronization processing, that is, firstly adds the information about the received file data to the management information 50 in the large-capacity file storage apparatus 10 (SP807).

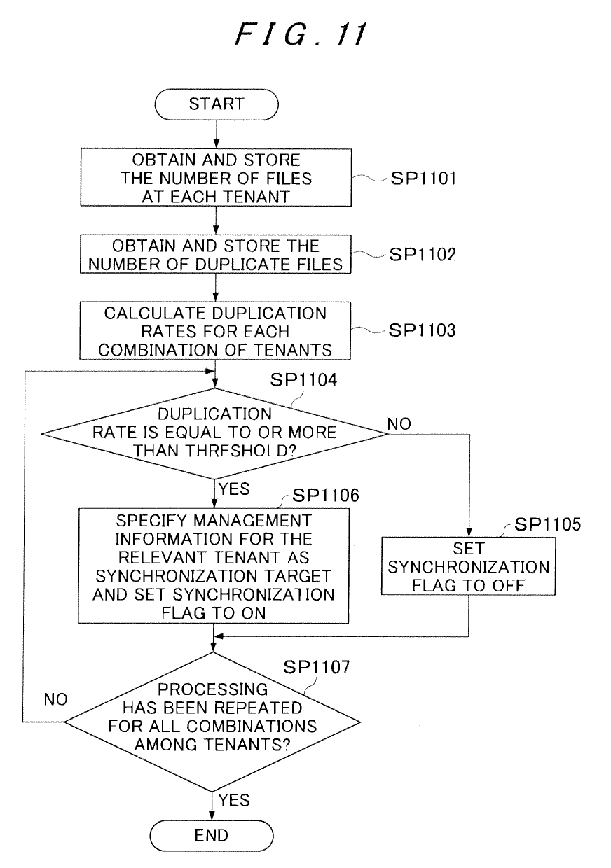

Next, the management information processing program 44 synchronizes such management information 50 with the management information 27 retained by each of the file storage apparatuses 7 at bases 2 (SP808). The specific details of this processing will be described later (see FIG. 11). Then, the management information processing program 44 terminates this management information synchronization processing.

It should be noted that from the perspective of maintaining the consistency of the file storage apparatuses 7 with the large-capacity file storage apparatus 10, it is desirable that the management information 27 retained by each of the file storage apparatuses 7 should be synchronized with the management information 50 retained by the large-capacity file storage apparatus 10 at the time when the file data is registered in the large-capacity file storage apparatus 10; however, this method may result in frequent data updates of the file data between the bases 2 and the data center 3, so synchronization may also be performed at some interval such as once a day outside office hours.

(2-3) Overview of File Reference Processing

Next, the details of the data reference processing executed in the file storage apparatuses 7 in such computer system 1 will be described.

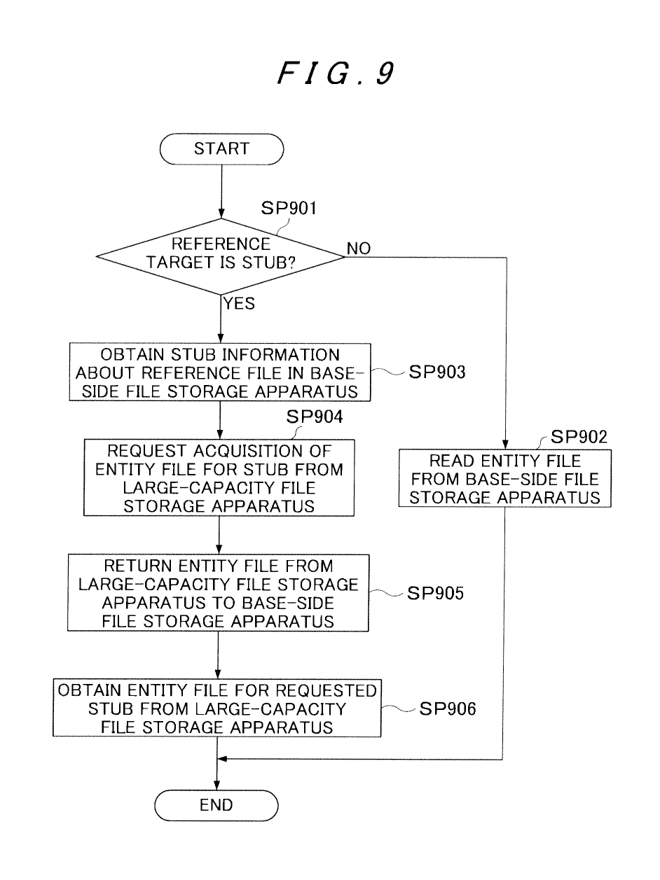

FIG. 9 shows a processing sequence for such file reference processing. This file reference processing is started by the file reference processing program 23 when a file data reference request is made from the business server 5 and the client 6 at the bases 2. Then, the file reference processing program 23 judges whether the target file data is a stub 29 or not (SP901).

If a negative judgment is returned, the file reference processing program 23 obtains the entity file 28 of the target file data from the file system 9 in the file storage apparatus 7 at the base 2, provides the file data to the business server 5 and the client 6 and then terminates this file reference processing (SP902).

Meanwhile, if an affirmative judgment is returned in step SP901, the file reference processing program 23 obtains the stub 29 of the target data from the file system 9 in the file storage apparatus 7 at the base 2 (SP903).

Then, the file reference processing program 23 requests the acquisition of the entity file 51, to which the stub 29 refers (is linked), from the large-capacity file storage apparatus 10 on the data center 3 side (SP904).

In response to the request from the file reference processing program 23 on the base 2 side, the file reference processing program 42 on the data center 3 side returns the file data of the entity file 51 of the required stub 52 to the file storage apparatus 7 on the base 2 side (SP905).

Then, the file reference processing program 23 obtains the entity file 51 of the requested stub 52 from the tenant 12 in the large-capacity file storage apparatus 10 linked by the stub 52, provides the file data to the business server 5 and the client 6 (SP906), and then terminates this file reference processing.

(2-4) Overview of File Deletion Processing

Next, the details of the deletion processing executed in the large-capacity file storage apparatus 10 which received a file data deletion request from the file storage apparatus 7 in such computer system 1 will be described.

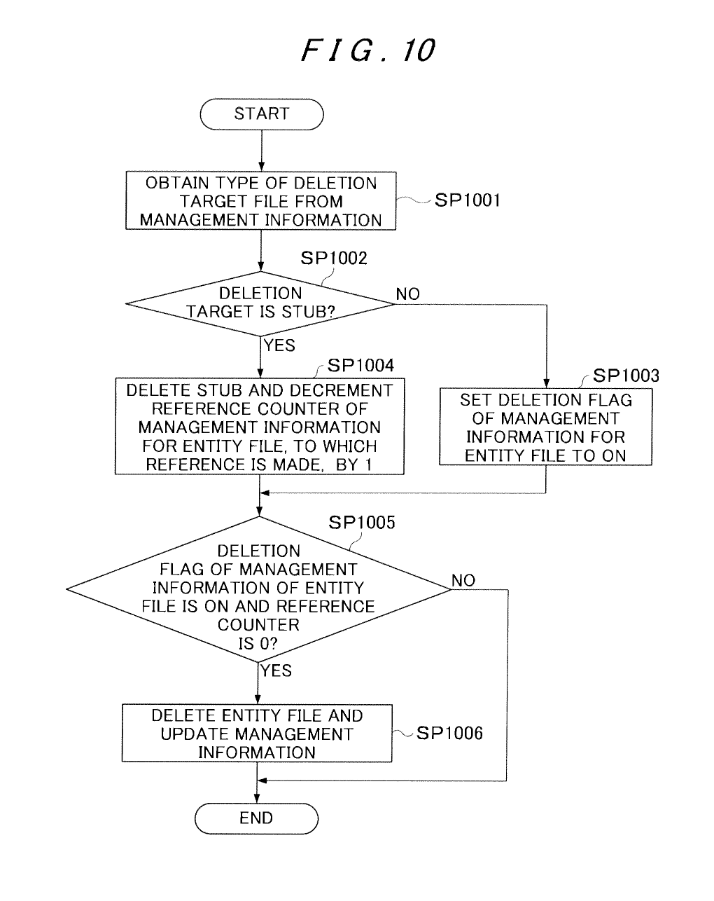

If a file data deletion request is issued from the client 6 of the bases 2 to the file storage apparatus 7, this deletion request is transferred from the file storage apparatus 7 to the large-capacity file storage apparatus 10. After receiving this deletion request, the file deletion processing program 43 of the large-capacity file storage apparatus 10, deletes the specified file data from the large-capacity file storage apparatus 10 in accordance with a processing sequence for the file deletion processing shown in FIG. 10.

Specifically speaking, after such deletion request is issued from any of the file storage apparatuses 7, the file deletion processing program 43 starts this file deletion processing, that is, firstly obtains information about the deletion target file data specified by the deletion request from the management information 50 (SP1001).

Then, the file deletion processing program 43 judges, based on the information obtained in step SP1001, whether the deletion target file data is replaced with a stub or not (SP1002).

If a negative judgment is returned, the file deletion processing program 43 sets the deletion flag stored in the deletion flag field 66 of the entry corresponding to the file data in the management information 50 to ON (SP1003).

Meanwhile, if an affirmative judgment is returned in step SP1002, the file deletion processing program 43 deletes the stub 52 of the deletion target file from the corresponding tenant 12. Furthermore, along with the deletion of the stub 52, the file deletion processing program 43 decrements the reference counter number stored in the reference counter field 67 of the entry in the management information 50 corresponding to the entity file 51, to which the stub 52 refers, by one (SP1004).

Subsequently, the file deletion processing program 43 refers to the deletion flag field 66 and the reference counter field 67 in the management information 50 and judges whether or not the deletion flag of the target entity file 51 is ON and, at the same time, the reference counter number is 0 (SP1005).

If an affirmative judgment is returned in step SP1005, the file deletion processing program 43 deletes the entity file 51, updates the management information 50 (SP1006), and then terminates the file deletion processing.

Meanwhile, if a negative judgment is returned in step SP1005, that means reference from the stub 52 remains, so the file deletion processing program 43 terminates the file deletion processing without deleting the entity file 51 or updating the management information 50.

It should be noted that the file deletion processing program 43 then synchronizes the updated management information 50 in the large-capacity file storage apparatus 10 on the data center 3 side with the management information 27 in the file storage apparatuses 7 on the bases 2 side. When transmitting the management information 50 to each base 2, the program selects and transmits the information of the base, whose de-duplication effects are high (exceeding the de-duplication threshold), in accordance with the duplication rate evaluation information. Furthermore, the information to be transmitted may also be selected so that the data communication amount between the bases 2 and the data center 3 will be reduced.

(2-5) Overview of Synchronization Target Base Determination Processing

Next, the synchronization target base determination processing executed in the large-capacity file storage apparatus 10 will be described.

Based on the judgment result in the above-described synchronization target base determination processing, the file storage apparatus 7 on the base 2 side can receive the management information 50 of the tenants 12 corresponding to the other selected bases 2 from the large-capacity file storage apparatus 10 on the data center 3 side in addition to the management information 50 of the tenant 12 corresponding to its own base 2, so that the communication amount between the bases 2 and the data center 3 can be kept smaller and, therefore, the higher de-duplication effect can be expected.

FIG. 11 shows a processing sequence for processing for determining the synchronization target bases 2 of the management information 50 (hereinafter referred to as the synchronization target base determination processing). This synchronization target base determination processing is executed by the inter-base duplication rate evaluation program 45 of the large-capacity file storage apparatus 10 on the data center 3 side. Then, after starting this synchronization target base determination processing, the inter-base duplication rate evaluation program 45 firstly obtains the total number of files (entity files 51 and stubs 52) between the tenants and stores this information in the total-number-of-data-in-link-tenant field 83 of the inter-base duplication rate evaluation information table (SP1101).

Subsequently, the inter-base duplication rate evaluation program 45 obtains the number of files of the duplicate file data between the tenants 12 and stores the obtained number of files of the duplicate file data in the number-of-duplicates field 82 of the inter-base duplication rate evaluation information table (SP1102).

Next, the inter-base duplication rate evaluation program 45 calculates the duplication rate between each pair of the tenants 12 from the total number of files (entity files 51 and stubs 52) and the number of files of the duplicate file data (SP1103).

Subsequently, the inter-base duplication rate evaluation program 45 judges whether the duplication rate between the tenants 12 is equal to or more than a threshold or not (SP1104). It should be noted that in this embodiment, the processing is executed, assuming the threshold to be 10%.

It should be noted that if a negative judgment is returned in step SP1104, the inter-base duplication rate evaluation program 45 determines that the effect of de-duplication between an evaluating tenant 12 and an evaluated tenant 12 is low; and sets the flag stored in the judgment result flag field 85 to OFF (SP1105).

Meanwhile, if an affirmative judgment is returned in step SP1104, the inter-base duplication rate evaluation program 45 determines that the effect of de-duplication between the evaluating tenant 12 and the evaluated tenant 12 is high; and sets the flag stored in the judgment result flag field 85 of the inter-base duplication rate evaluation information table to ON (SP1106).

Subsequently, the inter-base duplication rate evaluation program 45 judges whether or not the processing of steps from SP1104 to SP1106 has been repeated for all the combinations of the tenants 12 (SP1107). If an affirmative judgment is returned in this step, the inter-base duplication rate evaluation program 45 terminates this synchronization target base determination processing. Meanwhile, if a negative judgment is returned in this step, the inter-base duplication rate evaluation program 45 returns to step SP1104 and executes the processing.

(2-6) Overview of Management Information Synchronization Processing

Next, the details of processing for synchronizing the management information 50 retained by the large-capacity file storage apparatus 10 on the data center 3 side with the file storage apparatuses 7 on the base 2 side in such computer system 1 will be described.

It should be noted that as for the timing of synchronization, the system administrator sets an appropriate period by using the client 6 in consideration of the communication band for each base and the center, the number of bases, and the performance of the file storage apparatuses. If the synchronization processing is executed frequently, it will increase a data transmission amount significantly. So, the synchronization processing may be executed once a day.

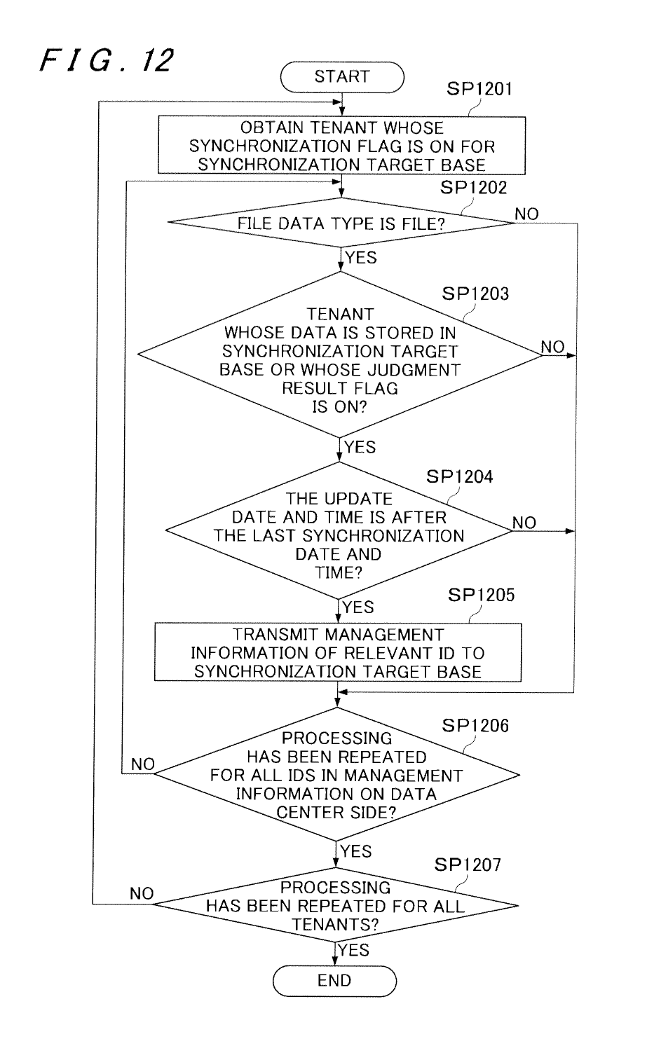

FIG. 12 shows a processing sequence for the synchronization processing for the management information 50. This management information synchronization processing is started by the management information processing program 44 of the data center 3. The management information processing program 44 refers to the inter-base duplication rate information about the tenants 12 associated with the bases 2, to which the management information 50 is about to be transmitted based on the inter-base duplication rate evaluation information, and obtains the information about the tenant 12 (base) whose judgment result flag field 85 is set to ON (SP1201).

Subsequently, the management information processing program 44 refers to the management information 50 retained by the large-capacity file storage apparatus 10 on the data center 3 side, and judges whether the type of the target file data is an entity file 51 or not (SP1202). If a negative judgment is returned in this step, the management information processing program 44 proceeds to step SP1206.

If an affirmative judgment is returned in step SP1202, the management information processing program 44 judges whether the flag stored in the judgment result flag field 85 corresponding to the tenant 12 where the target file data is stored is set to ON or not (SP1203). If a negative judgment is returned in this step, the management information processing program 44 proceeds to step SP1206.

Meanwhile, if an affirmative judgment is returned in step SP1203, the management information processing program 44 refers to the update date and time field 70 of the management information 50 about the target file data, and checks whether or not the update date and time is after the date and time of the last synchronization (SP1204). If a negative judgment is returned in this step, the management information processing program 44 proceeds to step SP1206.

If an affirmative judgment is returned in step SP1204, the management information processing program 44 transmits the management information 50 about the relevant entity file ID to the synchronization target base 2 (SP1205).

Subsequently, the management information processing program 44 judges whether or not the processing of steps from SP1202 to SP1205 has been repeated for all the entries stored in the management information 50 retained by the large-capacity file storage apparatus 10 on the data center 3 side (SP1206). If an affirmative judgment is returned, the management information processing program 44 proceeds to step SP1207. Meanwhile, if a negative judgment is returned in this step, the management information processing program 44 returns to step SP1202 and executes the processing.

In step SP1207, the management information processing program 44 judges whether or not the processing of steps from SP1201 to SP1206 has been repeated for all the tenants 12 (SP1207). If an affirmative judgment is returned, the management information processing program 44 terminates the processing. Meanwhile, if a negative judgment is returned in this step, the management information processing program 44 returns to step SP1201 and executes the processing.

It should be noted that in the initial state, the file storage apparatus 7 at each base 2 has not received the management information 50 retained by the large-capacity file storage apparatus 10 on the data center 3 side, so the file storage apparatus 7 at each base 2 cannot check duplicate file data until the first synchronization timing.

Therefore, at the first synchronization timing after the data registration from each base 2, the management information 50 is transmitted from the large-capacity file storage apparatus 10 on the data center 3 side to the file storage apparatuses 7

on the base 2 side and synchronized with the file storage apparatuses 7. After the transmission and synchronization of the management information 50, duplicate data can be checked in the file storage apparatuses 7 on the base 2 side based on the management information 50.

Furthermore, in a case where a base 2 is newly added, similarly, the file storage apparatus 7 of the new base 2 has not received the management information 50 retained by the large-capacity file storage apparatus 10 on the data center 3 side, so the file storage apparatus 7 at the new base 2 cannot check duplicate file data until the first synchronization timing. After the management information 50 is transmitted from the large-capacity file storage apparatus 10 on the data center 3 side to the file storage apparatus 7 at the new base 2 and synchronized with the file storage apparatus 7, duplicate file data can be checked in the new base 2 to confirm the duplicate file data based on the management information 27 stored in the file storage apparatus 7 at the base 2.

If an entity file registered from the base 2 in the initial state or the newly added base 2 is a duplicate of an entity file of another base 2, de-duplication is performed by the de-duplication function between the tenants 12 retained by the large-capacity file storage apparatus 10 on the data center 3 side. The result is reflected in the management information 50 of the large-capacity file storage apparatus 10 on the data center 3 side, which is further synchronized with the management information 27 of the file storage apparatus 7 at each base 2 at the next synchronization timing.

(2-7) Overview of Base Addition Processing

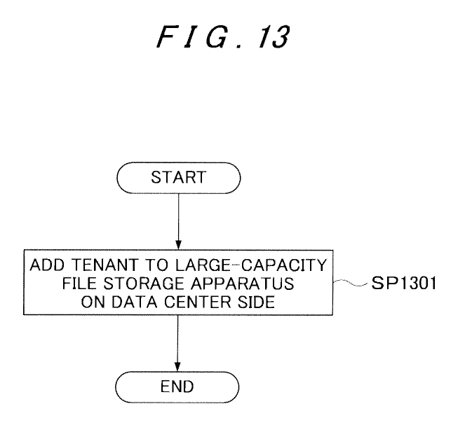

Next, the details of the base addition processing executed in the large-capacity file storage apparatus 10 in such computer system 1 will be described. FIG. 13 shows a processing sequence for the base addition processing executed by the management information processing program 44 of the large-capacity file storage apparatus 10 when a new base 2 is added by the system administrator giving a base addition command to the large-capacity file storage apparatus 10 directly or via a management server (not shown in the drawing).

Practically, after receiving such base addition instruction, the management information processing program 44 starts this base addition processing and adds a tenant 12 corresponding to the new base 2 in the data HDD 11 (SP1301). Specifically speaking, the management information processing program 44 secures a storage area to be used as such tenant 12 in the data HDD 11 in this step SP1301. Then, the management information processing program 44 terminates this base addition processing.

Incidentally, the computer system 1 may also be configured so that software for monitoring the addition of a base(s) 2 is stored in, for example, the program memory 41 at the data center 3; and if the relevant software detects a new base 2, the software reports the detected new base to the management information processing program 44 and the management information processing program 44 executes the above-described base addition processing as triggered by the above report.

Since no file data is stored in the tenant 12 which is added to the data HDD 11 of the large-capacity file storage apparatus 10 in the initial state, no information related to the added tenant 12 is registered in the management information 50 stored in the data HDD 11, either.

If a tenant 12 corresponding to the new base 2 is created in the data HDD 11, the archive data of the entity files 28 and the stubs 29 stored in the file storage apparatus 7 at the relevant base 2 is archived to the tenant 12. Furthermore, the information about such entity files 51 and stubs 52 archived to the tenant 12 is registered in the management information 50 stored in the data HDD 11.

(2-8) Overview of Base Deletion Processing

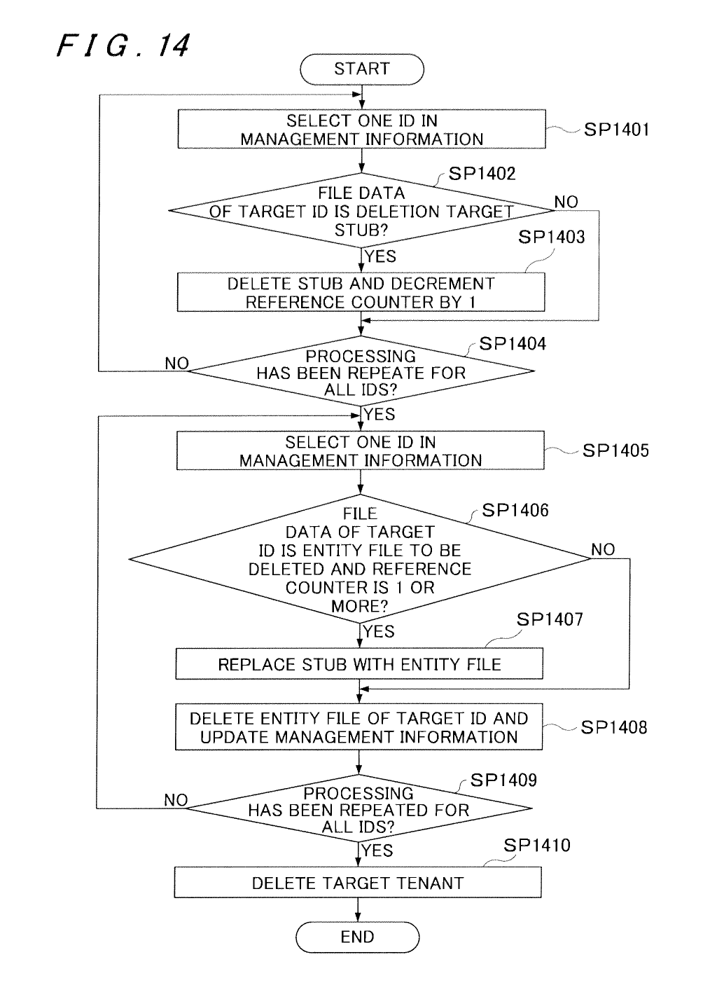

Next, the details of the base deletion processing executed in the large-capacity file storage apparatus 10 in such computer system 1 will be described. FIG. 14 shows a processing sequence for the base deletion processing executed by the management information processing program 44 of the relevant large-capacity file storage apparatus 10 when a base 2 is deleted by the system administrator giving a base deletion command to the large-capacity file storage apparatus 10 directly or via the management server which is not shown in the figure.

Specifically speaking, after receiving such base deletion instruction, the management information processing program 44 starts this base deletion processing, that is, firstly selects one entry from the management information 50 retained by the large-capacity file storage apparatus 10 (SP1401).

Then, the management information processing program 44 judges whether the entry obtained in step SP1401 is the stub 52 information stored in the target tenant 12 or not (SP1402). If a negative judgment is returned, the management information processing program 44 proceeds to step SP1404.

If an affirmative judgment is returned in step SP1402, the management information processing program 44 deletes the target stub 52 from the tenant 12 corresponding to the base 2 to be deleted. Then, the management information processing program 44 deletes the entry of the target stub 52 from the management information 50, and further decrements (decreases by one) the reference counter number of the management information 50 of the entity file 51 to which the stub 52 refers (SP1403).

In step SP1404, the management information processing program 44 judges whether or not the processing of steps from SP1401 to SP1403 has been repeated for all the entries stored in the management information 50 of the data HDD 11 for the large-capacity file storage apparatus 10 (SP1404). If an affirmative judgment is returned in this step, the management information processing program 44 proceeds to step SP1405. Meanwhile, if a negative judgment is returned, the management information processing program 44 returns to step SP1401 and executes the processing.

Subsequently, the management information processing program 44 selects one entry from the management information 50 retained by the large-capacity file storage apparatus 10 (SP1405).

Then, the management information processing program 44 judges whether or not the entry obtained in step SP1405 is the entity file 51 information stored in the target tenant 12 and its reference counter is 1 or more (SP1406). If a negative judgment is returned in this step, the management information processing program 44 proceeds to step SP1408.

If an affirmative judgment is returned in step SP1406, the management information processing program 44 refers to the stubs 52 stored in the other tenants 12, which refer to the entity file from their entries, and replaces one of them with an entity file 51 (SP1407).

The management information processing program 44 deletes the entity file 51 and further deletes the entry of the relevant entity file 51 from the management information 50 (SP1408).

In step SP1409, the management information processing program 44 judges whether or not the processing of steps from SP1405 to SP1408 has been repeated for all the entries of the management information 50 stored in the data HDD 11 for the large-capacity file storage apparatus 10 (SP1409). If an affirmative judgment is returned, the management information processing program 44 proceeds to step SP1410. Meanwhile, if a negative judgment is returned in this step, the management information processing program 44 returns to step SP1405 and executes the processing.

The management information processing program 44 deletes the tenant 12 corresponding to the specified base 2 from the data HDD 11 for the data center 3 (SP1410). Specifically speaking, the management information processing program 44 releases the storage area secured in the data HDD 11 as such tenant 12. Then, the management information processing program 44 terminates the base deletion processing.

Incidentally, the computer system 1 may be configured so that software for requesting deletion of the base 2 is stored in, for example, the program memory 41 in the data center 3; and if the relevant software receives a command to delete a base 2, the deletion command is reported to the management information processing program 44 and the management information processing program 44 executes the above-mentioned base deletion processing as triggered by this report.

### (3) Effects of This Embodiment

As described above, if file data of the same content is already saved in the large-capacity file storage apparatus 10 on the data center 3 side in the computer system 1 according to this embodiment, a stub 52 containing link information to the already saved file data is created, and the stub 52 is transmitted and registered from the file storage apparatuses 7 on the base 2 side to the large-capacity file storage apparatus 10 on the data center 3 side. As a result, the communication band between the file storage apparatuses at the bases and the center-side large-capacity file storage apparatus can be efficiently utilized.

If the target is a stub 52 when performing data deletion, the stub 52 is deleted and the reference counter of the entity file 51, to which the management information 50 of the large-capacity file storage apparatus 10 on the data center 3 side refers, is decremented by one. If the target is an entity file 51, the entity file 51 is deleted if the reference counter is 0. If any reference remains, the deletion flag (the flag indicating that a command to delete an entity file is issued) is set to ON, and the entity file 51 is not deleted until the reference counter becomes 0. As a result, the deletion of the entity file 51, to which any reference from the stub 52 remains, is prevented.

When transmitting the management information 50 to each base 2, the information about the base whose duplication rate and de-duplication effects are high (exceeding the de-duplication threshold) is selected and transmitted based on the duplication rate evaluation information. As a result, the communication data amount can be reduced more than the case where all pieces of the management information 50 retained by the data center to the respective bases 2.

### (4) Other Embodiments

It should be noted that in the above-mentioned embodiment, a threshold of 10% is set as the duplication rate in the synchronization processing of the management information 50 of the large-capacity file storage apparatus 10 on the data center 3 side; and when this threshold is used as a standard, if the duplication rate between the tenants 12 is lower than the threshold, it is determined that the de-duplication effect is low; and if the duplication rate is equal to or higher than the threshold, it is determined that the de-duplication effect is high; and in this manner, whether to share the management information 27 between each pair of the bases 2 is judged, and the data de-duplication processing is thereby executed. However, the invention is not limited to this example, and the data de-duplication processing between the tenants may be executed by using a duplication rate of each base 2 within its own base 2 as the threshold for judgment. Furthermore, the threshold to be the standard for the file data de-duplication processing may also be a value calculated by multiplying the duplication rate of each base 2 within its own base 2 by a fixed value, for example, 50%.

Furthermore, this embodiment described the case where in the file data de-duplication processing, whether any identical file data exists or not is judged with respect to the file storage apparatuses 7 on the base 2 side, by using file sizes and hash values. However, the invention is not limited to this example and whether any identical file data exists or not may be judged by checking, for example, the file names or the content of the files.

### REFERENCE SIGN LIST

1 Computer system
2 Base
3 Data center
4 Internet
5 Business server
6 Client
7 File storage apparatus
9 File system
10 Large-capacity file storage apparatus
12 Tenant
21, 41 Program memory
22 De-duplication processing program
23, 42 File reference processing program
24, 47 Processor
27, 50 Management information
28, 51 Actual file
29, 52 Stub
43 File deletion processing program
44 Management information processing program
45 Inter-base duplication rate evaluation program

1. A computer system comprising:
a plurality of first file storage apparatuses for, in response to a request from a higher-level device, storing and retaining file data of a file given from the higher-level device or providing the higher-level device with the file data of the stored and retained file; and
a second file storage apparatus for storing and retaining the file data of the file which is a target to be stored and is sent from each of the first file storage apparatuses;
wherein the first file storage apparatus obtains sameness judgment information to be used to judge sameness of the target file to be stored with another file, based on the file data of that file;
the first file storage apparatus compares the obtained sameness judgment information about the target file to be stored with the sameness judgment information about each file, which was reported by the second file storage apparatus in advance and stored and retained by the second file storage apparatus; and
if it is determined that the same file as the target file to be stored is not stored or retained in the second file storage apparatus; the first file storage apparatus sends the file data of the target file to be stored, to the second file storage apparatus; and if it is determined that the same file as the target file to be stored is stored and retained in the second file storage apparatus, the first file storage apparatus sends reference information, which refers to the file that is stored and retained in the second file storage apparatus and is the same as the target file to be stored, to the second file storage apparatus; and
wherein the second file storage apparatus manages the sameness judgment information about each file stored and retained on a file basis and notifies each first file storage apparatus of the sameness judgment information about the file.

2. The computer system according to claim 1, wherein the sameness judgment information is a hash value or file size of the file calculated based on the file data of the relevant file.

3. The computer system according to claim 1, wherein the second file storage apparatus selects the sameness judgment information about the file related to part of the first file storage apparatuses from among the sameness judgment information related to the plurality of first file storage apparatuses and reports such sameness judgment information to each first file storage apparatus.

4. The computer system according to claim 1, wherein the second file storage apparatus calculates a duplication rate indicating a degree of file duplication between the first file storage apparatuses with respect to each combination of the first file storage apparatuses; and
notifies each first file storage apparatus of the sameness judgment information about the file related to another first file storage apparatus whose duplication rate with the relevant first file storage apparatus exceeds a predetermined threshold.

5. The computer system according to claim 1, wherein the second file storage apparatus regularly calculates the duplication rate for each combination of the first file storage apparatuses.

6. The computer system according to claim 1, wherein in response to a file deletion request from the higher-level device, the first file storage apparatus sends the deletion request to the second file storage apparatus; and
wherein if a deletion target file is reference information, the second file storage apparatus deletes the reference information; and
if the deletion target file is file data and reference information which refers to the deletion target file does not exist, the second file storage apparatus deletes the file data.

7. The computer system according to claim 1, wherein the sameness judgment information is a hash value or file size of the file calculated based on the file data of the relevant file; and
wherein the second file storage apparatus calculates a duplication rate indicating a degree of file duplication between the first file storage apparatuses with respect to each combination of the first file storage apparatuses; and
notifies each first file storage apparatus of the sameness judgment information about the file related to another first file storage apparatus whose duplication rate with the relevant first file storage apparatus exceeds a predetermined threshold.

8. A data de-duplication method for a computer system including a plurality of first file storage apparatuses for, in response to a request from a higher-level device, storing and retaining file data of a file given from the higher-level device or providing the higher-level device with the file data of the stored and retained file, and a second file storage apparatus for storing and retaining the file data of the file which is a target to be stored and is sent from each of the first file storage apparatuses;
the data de-duplication method comprising:
a first step executed by the first file storage apparatus of: obtaining sameness judgment information to be used to judge sameness of the target file to be stored with another file, based on the file data of that file; comparing the obtained sameness judgment information about the target file to be stored with the sameness judgment information about each file, which was reported by the second file storage apparatus in advance and stored and retained by the second file storage apparatus; and sending the file data of the target file to be stored, to the second file storage apparatus if it is determined that the same file as the target file to be stored is not stored or retained in the second file storage apparatus; and sending reference information, which refers to the file that is stored and retained in the second file storage apparatus and is the same as the target file to be stored, to the second file storage apparatus if it is determined that the same file as the target file to be stored is stored and retained in the second file storage apparatus; and
a second step executed by the second file storage apparatus of managing the sameness judgment information about each file stored and retained on a file basis and notifying each first file storage apparatus of the sameness judgment information about the file required.

9. The data de-duplication method according to claim 8, wherein sameness judgment information is a hash value or file size of the file calculated based on the file data of the relevant file.

10. The data de-duplication method according to claim 8, wherein the second file storage apparatus selects the sameness judgment information about the file related to part of the first file storage apparatuses from among the sameness judgment information related to the plurality of first file storage apparatuses and reports such sameness judgment information to each first file storage apparatus.

11. The data de-duplication method according to claim 8, wherein in the second step, the second file storage apparatus calculates a duplication rate indicating a degree of file duplication between the first file storage apparatuses with respect to each combination of the first file storage apparatuses; and
notifies each first file storage apparatus of the sameness judgment information about the file related to another first file storage apparatus whose duplication rate with the relevant first file storage apparatus exceeds a predetermined threshold.

12. The data de-duplication method according to claim 8, wherein the second file storage apparatus regularly calculates the duplication rate for each combination of the first file storage apparatuses.

13. The data de-duplication method according to claim 8, wherein in response to a file deletion request from the higher-level device, the first file storage apparatus sends the deletion request to the second file storage apparatus; and
wherein if a deletion target file is reference information, the second file storage apparatus deletes the reference information; and
if the deletion target file is file data and reference information which refers to the deletion target file does not exist, the second file storage apparatus deletes the file data.

14. The data de-duplication method according to claim 8, wherein the sameness judgment information is a hash value or file size of the file calculated based on the file data of the relevant file; and
wherein the second file storage apparatus calculates a duplication rate indicating a degree of file duplication between the first file storage apparatuses with respect to each combination of the first file storage apparatuses; and
notifies each first file storage apparatus of the sameness judgment information about the file related to another first file storage apparatus whose duplication rate with the relevant first file storage apparatus exceeds a predetermined threshold.
